(19) United States
(12) Patent Application Publication
(10) Pub. No.: US 2014/0326346 A1
(43) Pub. Date: Nov. 6, 2014

(54) COUPLING

(71) Applicants: Timothy Marquis, Otsego, MN (US); Michael Gose, Frederic, WI (US); Andrew Holst, Eden Prairie, MN (US); Steve Maher, St. Anthony, MN (US)

(72) Inventors: Timothy Marquis, Otsego, MN (US); Michael Gose, Frederic, WI (US); Andrew Holst, Eden Prairie, MN (US); Steve Maher, St. Anthony, MN (US)

(73) Assignee: PARKER-HANNIFIN CORPORATION, Cleveland, OH (US)

(21) Appl. No.: 14/363,342

(22) PCT Filed: Jul. 17, 2012
(86) PCT No.: PCT/US2012/047033

§ 371 Date: Jun. 6, 2014

Related U.S. Application Data
(60) Provisional application No. 61/567,711, filed on Dec. 7, 2011.

(51) Int. Cl. F16L 37/34; F16L 21/00

(52) U.S. Cl. CPC F16L 37/34; F16L 21/00
USPC 137/798; 285/399; 285/334.5

(57) ABSTRACT

A fluid coupling member (11) includes a housing (20) having a bore (35). A poppet (41) is slidably disposed in the bore (35). The poppet (41) engages a generally cylindrical seating surface (36) to close the bore when the poppet (41) is in a closed position. The poppet (41) is moveable in one direction to a first opened position (FIG. 3) against the bias of a spring assembly (42, 43, 44) when the fluid coupling member (11) is connected to a second coupling member (12). The poppet (41) moves in the opposite direction to a second opened position (FIG. 2) against the bias of the spring assembly when the fluid coupling member (11) is disconnected from the second coupling member (12). A filter (246) (FIG. 7) includes an enlarged diameter portion (246c) disposed in a conical opening between an enlarged diameter bore portion (239b) and a flaring member (250).

### RELATED APPLICATION

This application claims priority of U.S. Provisional Application No. 61/567,711 filed on Dec. 7, 2011, which is hereby incorporated by reference in its entirety.

### TECHNICAL FIELD

This invention relates to couplings for fluid systems. More specifically, this invention relates to quick connect couplings for selectively connecting and disconnecting components in a fluid system.

### BACKGROUND OF THE INVENTION

Fluid couplings are used to connect and disconnect components in a fluid system. Fluid couplings may include a first coupling member that is attached to a first fluid component in the system and a second coupling member that is attached to a second fluid component of the system. The first and second coupling members of the fluid coupling may be connected to establish a fluid connection between the first and second fluid components and may be disconnected to terminate the fluid connection.

Many fluid couplings use a quick connect locking sleeve and locking balls to lock the coupling members together when they are assembled and to unlock the coupling members to allow disconnection. The locking sleeve in these couplings may be spring biased to a locked position to hold the locking balls in a position to lock the coupling members together. The locking sleeve may be retracted against the spring bias to an unlocked position to allow retraction of the locking balls and disconnection. Fluid couplings of this type facilitate rapid or quick connection and disconnection of the coupling members without tools.

Additionally, fluid couplings may include main valves in one or both fluid coupling members that open to permit fluid flow when the coupling members are connected and that close to prevent leakage when the coupling members are disconnected. Further, fluid couplings may include a fluid filter to remove contaminants from a fluid flowing through the couplings. Still further, fluid couplings may include a separate pressure relief valve in one of the coupling members that opens to vent excess fluid pressure on the back side or upstream side of the main valve. Fluid couplings with pressure relief valves and/or with filters may include a relatively large number of relatively small parts that can be time consuming or costly to manufacture and/or to assemble.

### SUMMARY OF THE INVENTION

The present invention provides a fluid coupling member for a fluid system. The coupling member includes a valve assembly. The valve assembly has a normally closed configuration in which the valve assembly closes to prevent leakage when the coupling member is disconnected from an associated coupling member. The valve assembly opens by movement in one longitudinal direction to permit fluid flow through the coupling member when the coupling member is connected to its associated coupling member. The valve assembly also opens by movement in an opposite longitudinal direction to vent excess fluid pressure on the back side of the valve assembly. After opening in the opposite longitudinal direction, the valve assembly may be blocked from returning to its closed position, to provide a visual indicator that excess fluid pressure has been vented and to prevent recoupling of the first and second coupling members. One of the coupling members may include a retainer, which is preferably a porous metal fluid filter that has a cup shape. The open end of the retainer may be flared outwardly during assembly into the coupling member, to secure the main valve in position.

More specifically, the fluid coupling member includes a housing and a bore in the housing that has a longitudinal axis. A valve assembly in the housing includes a poppet slidably disposed in the bore. A valve seating surface is disposed in the bore between ends of the housing. A spring assembly biases the poppet toward a closed position engaging the valve seating surface to fully close fluid communication between the ends of the bore. The poppet is movable in one longitudinal direction toward one of the ends against the bias of the spring assembly to open fluid communication between the ends during one mode of operation. The poppet is also movable in another longitudinal direction opposite the one direction against the bias of the spring assembly to open fluid communication between the ends during another mode of operation.

One of the longitudinally spaced ends of the bore is a fluid coupling member interface end, and the other of the longitudinally spaced ends is a fluid component attachment end. The poppet is movable toward the fluid component attachment end when the coupling member is connected to another coupling member. The poppet is movable away from the fluid component attachment end when the coupling member is disconnected from the other coupling member, in response to excess pressure in the fluid component attachment end of the bore to vent such excess pressure.

The spring assembly may include a valve spring that biases the poppet toward the fluid coupling interface end when the coupling member is connected to another coupling member, and a pressure relief spring that biases the poppet toward the fluid component attachment end when the coupling member is disconnected from the other coupling member. The spring assembly includes a valve guide, and the valve guide is longitudinally slidable relative to the housing bore and relative to the poppet. The valve spring acts between the poppet and the valve guide and the pressure relief spring acts between the housing and the valve guide. The spring assembly may alternatively include a single spring, and the single spring may bias the poppet toward its closed position when the poppet is moved in the direction toward the fluid coupling interface end of the housing and may also bias the poppet toward its closed position when the poppet is moved in the other direction toward the fluid component attachment end of the housing. In the single spring arrangement, the spring assembly includes two valve guides, with each of the valve guides slidable relative to the housing and relative to the poppet and with the spring acting between the two valve guides.

The seating surface may be a generally cylindrical surface, and the poppet may include an elastomeric seal. The seal has a resiliently deformed outside diameter engaging the generally cylindrical seating surface when the poppet is in the closed position. The elastomeric seal has a free diameter substantially greater than its resiliently deformed diameter when the poppet is in the open position in the direction away from the fluid component attachment end. The portion of the seal intermediate its resiliently deformed diameter and its free diameter engages a portion of the interface end of the housing to retain the poppet in the open position against the bias of the spring assembly after the poppet is moved from its closed position to its open position toward the interface end.

The bore may include a filter or retainer receiving bore portion near the fluid component attachment end of the bore. The receiving portion of the bore includes a generally cylindrical nominal diameter portion and a larger diameter portion intermediate the nominal diameter portion and the seating surface. A retainer, which may be a porous metal filter, is disposed in the receiving portion of the bore. The retainer has a nominal diameter portion disposed in the nominal diameter receiving portion of the bore and a larger diameter portion disposed in the larger diameter receiving portion of the bore. The larger diameter receiving portion of the bore is generally conical. A flaring member is disposed in the larger diameter receiving portion of the bore, and the flaring member and the larger diameter receiving portion of the bore define a generally conical space into which the larger diameter portion of the retainer is received. The retainer secures the valve assembly and the spring assembly in the bore.

The invention further provides various ones of the features and structures and methods described in the detailed description and in the claims set out below, alone and in combination, and the claims are incorporated by reference in this summary of the invention.

### BRIEF DESCRIPTION OF THE DRAWINGS

Embodiments of this invention are described in further detail below with reference to the accompanying drawings, in which:

FIG. 1 is a longitudinal cross sectional view of a fluid coupling member according to a first preferred embodiment of this invention, with the coupling member in a closed configuration;

FIG. 2 is a longitudinal cross sectional view of the fluid coupling member shown in FIG. 1, with the coupling member in a vent configuration;

FIG. 3 is a longitudinal cross sectional view of the fluid coupling member shown in FIG. 1, with the coupling member in an opened configuration and with the coupling member shown assembled to a second coupling member;

FIG. 4 is a longitudinal cross sectional view of a second preferred embodiment of a fluid coupling member according to this invention, with the coupling member in a closed configuration;

FIG. 5 is a longitudinal cross sectional view of the fluid coupling member shown in FIG. 4, with the coupling member in a vent configuration;

FIG. 6 is a longitudinal cross sectional view of the fluid coupling member shown in FIG. 4, with the coupling member in an opened configuration and with the coupling member shown assembled to a second coupling member; and

FIG. 7 is a longitudinal cross sectional view of a third preferred embodiment of a fluid coupling member according to this invention, with the coupling member in a closed configuration.

### DETAILED DESCRIPTION OF THE INVENTION

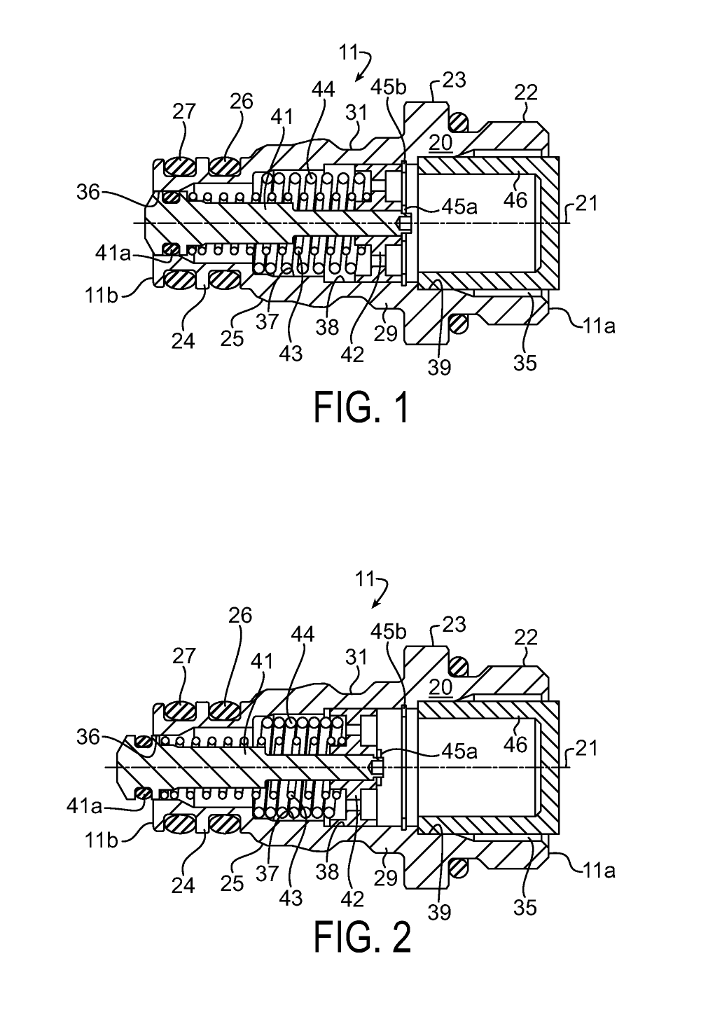

Referring now to the drawings in greater detail, FIGS. 1 through 3 illustrate a first preferred embodiment of a fluid coupling 10 having a first coupling member 11 and a second coupling member 12. Various aspects of the coupling members 11 and 12 are further described in U.S. Provisional Patent Application Ser. No. 61/508,744, filed on Jul. 18, 2011, the entirety of which is incorporated herein by reference (“Referenced patent application”). Fluid flow through the coupling 10 in the first preferred embodiment is for most uses from the first coupling member 11 to the second coupling member 12. In one exemplary application for the coupling 10, the first coupling member 11 is attached to a component (not shown) of a system (not shown) and is used to connect and disconnect that component from other components (not shown) of the system. For example, the first coupling member 11 in the preferred embodiment may be attached on its right or inlet side 11a as viewed in the drawings to a fluid component, and the right side of the first coupling member 11 may be referred to as the fluid component attachment side or end of the coupling member 11. In the preferred embodiment, the fluid component attachment end 11a of the first coupling member 11 may be attached to a canister that generates a gas, such as ammonia, that is dispensed into a fossil fuel diesel engine exhaust system. The left or outlet side 11b of the first coupling member 11 may be attached to another coupling member such as the coupling member 12, and the left side may be referred to as the fluid coupling interface end of the coupling member 11. In the preferred embodiment, the right side of the second coupling member 12 is the fluid coupling interface end that interfaces with the first coupling member 11. The left or outlet side of the second coupling member 12 is the fluid component end and is connected to another fluid component, such as a fluid connector that carries the fluid to a component such as a diesel engine exhaust member (not shown). In this application, the coupling 10 may be used to connect and disconnect the above described ammonia gas canister to and from the above described diesel engine exhaust. Flow direction through the coupling 10 may be reversed, for example when the canister is being refilled. Also, the longitudinal axis 21 of the coupling member 10 may arranged at an angle of, for example, 90 degrees or 45 degrees, so that the component attachment end 11a and the interface end 11b are arranged at an angle to one another. Many other uses or applications for the fluid coupling member 11 and its associated coupling member 12 are also possible, and the described use or application for the coupling member 11 is provided for purposes of example or illustration.

As shown in FIG. 1, the first coupling member 11 includes a hollow, generally cylindrical metal body or housing 20, preferably formed of a ferrous material such as American Society for Testing and Materials (ASTM) 303 stainless steel material. The body 20 has a longitudinal axis 21. The exterior of the body 20 includes an externally threaded end portion 22, a wrench flat gripping portion 23, a nominal diameter generally cylindrical coupling sealing portion 24, and a generally conical ramp portion 25. The externally threaded end portion 22 is threadably connected to a mating threaded portion (not shown) of a fluid system component (not shown), such as for example the ammonia gas canister described above, using the wrench flats 23.

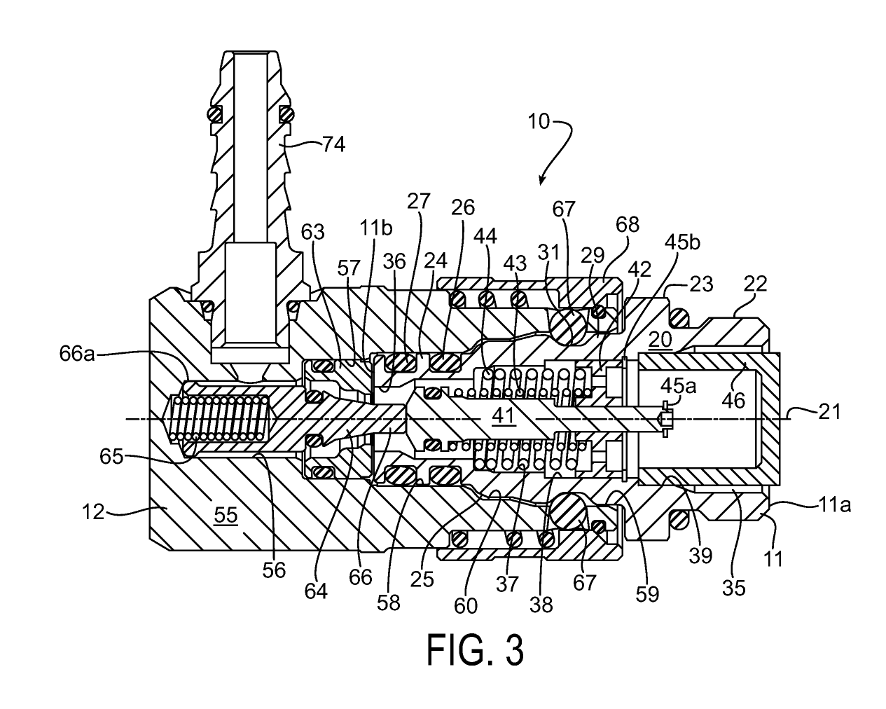

The coupling sealing portion 24 of the first coupling member 11 is received within the second coupling member 12 when the first coupling member 11 is connected to the mating second coupling member 12 as illustrated in FIG. 3, to establish open fluid communication between the fluid component end 11a of the coupling member 11 and the coupling interface end 11b. A spring loaded internal valve mechanism described further below closes the interior of the coupling member 11 when the coupling member 11 is disconnected from the mating or associated second coupling member 12 and when the coupling member 11 is in partially connected configurations. The coupling sealing portion 24 carries and includes two annular elastomeric O-rings 26 and 27, each of which is secured in an O-ring groove on the exterior surface of the mating sealing portion 24. The ramp 25 connects the sealing portion 24 to a larger diameter generally cylindrical locking portion 29 of the coupling body 20 which includes an exterior locking surface.

Still referring to FIG. 1, the larger diameter generally cylindrical locking portion 29 of the first coupling member 11 further includes an annular ball locking groove 31, and the ramp portion 25 extends axially from the sealing portion 24 to the ball locking groove 31. The locking portion 29 and locking groove 31 each have a diameter greater than the diameter of the sealing portion 24 and elastomeric seals 26 and 27. The ramp portion 25 includes a radially outermost crest portion adjacent the locking portion 29.

The hollow generally cylindrical metal body 20 includes a stepped passage or bore 35 extending longitudinally from end to end through the body 20. A generally cylindrical O-ring seating surface 36 is provided at the left end of the first coupling member 11. First, second and third progressively enlarged diameter stepped bores 37, 38 and 39 extend from the O-ring seating surface 36 to the right end of the coupling member 11 as viewed in the drawings.

The first coupling member 11 further includes a valve poppet 41 that carries and includes an O-ring seal 41a on its left end that selectively engages and disengages the cylindrical O-ring seating surface 36 to open and close fluid flow from the fluid component end 11a to the coupling interface end 11b through the coupling member 11 as further described below. The valve poppet 41 is slidably arranged in the bore 35 and is slidably carried by an annular valve guide 42 which is slidably arranged in the second stepped bore 38 of the body 20. A spring assembly includes a valve spring 43 that acts between the valve guide 42 and the valve poppet 41 to bias the valve poppet 41 and seal 41a to the left (toward the interface end 11b and away from the component end 11a) to the closed position or configuration shown in FIG. 1. In this position, the valve guide 42 is biased against a retaining ring or retainer 45a on the right end of the poppet 41. The outer diameter of the seal 41a is elastically deformed from its free diameter to a reduced sealing diameter and sealingly engages the cylindrical seating surface 36. The spring assembly further includes a pressure relief spring 44 acts between the body 20 and the valve guide 42 to bias the valve guide 42 against a retaining ring or retainer 45b.

A retainer, which may be a stainless steel sintered porous powdered metal fluid filter 46, includes a hollow generally cylindrical portion that is closed at its inlet end by a disk shaped end. The bore portion 39 provides a retainer receiving bore portion, and the porous powdered metal fluid filter 46 is preferably press fit in the bore portion 39. The fluid filter 46 is upstream of the valve poppet 41 and seal 41a and valve guide 42, to filter contaminants from the fluid as it flows from the above described canister before the fluid reaches those components. As further described below, the valve poppet 41 is movable between a closed position (FIG. 1), a pressure relief position (FIG. 2) and a fully opened position (FIG. 3). The valve poppet 41 is also movable to and from partially opened positions not shown in the drawings but shown and described in the Referenced patent application.

Referring now to FIG. 3, the second coupling member 12 includes a generally cylindrical body or housing 55 preferably formed of a ferrous material such as ASTM 303 stainless steel material. The body 55 is coaxial with the axis 21 of the first coupling member 11 in all of the configurations shown in the drawings. A stepped blind bore extends from the right end of the body 55 and includes progressively enlarged first, second, third and fourth stepped bores 56, 57, 58 and 59. The stepped bore 58 provides a generally cylindrical sealing portion or sealing surface of the second coupling member 12. A seal retention or blow out prevention surface 60 is provided intermediate the stepped bores 58 and 59. The blow out prevention surface 60 is preferably generally cylindrical, but may be conical or of other geometric shape. The structure and function of the blow out prevention surface 60 is further described in the Referenced Patent Application.

A valve seat 63 is press fit in the second bore portion 57, and a valve poppet 64 is biased by a spring 65 to a closed position against the seat 63. The preloads and spring rates of the springs 43 and 65 are preferably selected so that the spring 43 is slightly stronger than the spring 65 in the preferred embodiment, so that the valve poppet 64 opens slightly before the poppet 41 opens, as further discussed in the Referenced patent application. The valve poppet 64 includes a smaller diameter external peripheral surface portion that slides in the first stepped bore 56 and that defines a flow path for fluid when the coupling members 11 and 12 are in the fully connected position shown in FIG. 3. The valve poppet 64 also includes an elastomeric O-ring seal that provides a valve poppet surface which engages a valve seat surface of the valve seat 63 to close the valve mechanism in the second coupling member 12 when the coupling members 11 and 12 are in their partially connected positions further described in the Referenced patent application. The valve poppet 64 further includes a longitudinally extending nose guide portion 66 which extends rightward through the valve seat 63 toward the first coupling member 11. The nose guide portion 66 cooperates with an annular rib 66a on the left most end of the valve poppet 64 to provide a valve poppet guide as the coupling members are sequenced toward and away from their fully connected positions shown in FIG. 3, as more fully discussed below.

The fourth stepped bore 59 provides a locking portion or locking surface of the coupling member 12 and includes eight identical and circumferentially equally spaced tapered radial openings or holes, two of which are shown in the drawings. Spherical locking segments 67, two of which are shown in the drawings, are preferably locking balls that are arranged in each of the holes and project radially into the fourth stepped bore and radially outwardly to the exterior surface of the body 55. A spring biased locking sleeve 68 covers the balls 67 to hold them in a radially inward position when the coupling members 11 and 12 are in the coupled and fully opened configuration shown in FIG. 3.

The connection sequence for the coupling members 11 and 12, and the positions or configurations of various components of the coupling members 11 and 12 during the connection sequence, are illustrated and more fully described in the Referenced patent application. During this connection sequence, the closed coupling member 11 illustrated in FIG. 1 is inserted progressively into the open larger diameter bore 59, until the coupling members 11 and 12 reach the position illustrated in FIG. 3. In the FIG. 3 position, the valve poppets 41 and 64 engage and hold one another fully opened. The locking balls 67 in this position are held in a radially inward position by the sleeve 68 to lock the coupling members 11 and 12 together in this position. The poppet 41 is moved from its closed position illustrated in FIG. 1 to the right (toward the fluid component end 11a of the coupling member 11 and away from the coupling interface end 11b of the coupling member 11). To disconnect the coupling members 11 and 12 from the fully connected configuration shown in FIG. 3, the sleeve 68 is moved longitudinally to the left as viewed in FIG. 3 to release the locking balls 67 and allow the above described connection sequence to be reversed. The bore 35 immediately adjacent the right side (which is the fluid component side) of the seating surface 36 provides a smooth transition surface that facilitates the seal 41a re-entering the cylindrical seating surface 36 during disconnection of the coupling members 11 and 12. As shown in FIGS. 1-3, the transition surface of the bore 35 adjacent the right side of the cylindrical seating surface 36 is generally rounded or conical for this purpose.

When the coupling member 11 is disconnected from the coupling member 12, the right side or fluid component end 11a of the coupling member 11 remains connected to its associated fluid component (not shown in the drawings but described above). Under normal operating conditions, the poppet 41 and seal 41a are held in the closed positions illustrated in FIG. 1 during this mode of operation by the valve spring 43. In this mode of operation, the back side of the poppet 41 (which is the right side as viewed in FIG. 1) is exposed to fluid pressure in the associated fluid component. The closed poppet 41 and seal 41a seal against the seating surface 36 and prevent leakage fluid flow from the associated fluid component. If the fluid component reaches a fluid pressure higher than its design pressure or the design pressure of the fluid coupling member 11, the coupling member 11 provides a pressure relief function and acts to relieve this excess fluid pressure. For example, if the fluid component is a gas canister as described above, an exposure of the gas canister to excessively high ambient temperature as may occur in the event of a fire can cause the pressure within the gas canister and the pressure on the back side of the closed poppet 41 and seal 41a to increase to above design pressure levels. To relieve any such excess pressure, the poppet 41 and seal 41a move in a longitudinal direction toward the coupling interface end 11b and away from the fluid component end 11a to a vent position illustrated in FIG. 2. The excess pressure acts against the poppet 41 and moves the poppet 41 and valve guide 42 as a unit to the left as viewed in FIGS. 1 and 2 against the bias of the relief spring 44. This causes the seal 41a to move to the left out of engagement with the seating surface 36 as illustrated in FIG. 2, to allow the excess fluid pressure to escape from the back side of the valve poppet 41 and from the over pressurized fluid component. When the poppet 41 and seal 41a move in this manner, the outer diameter of the seal 41 increases from its sealing diameter to a free or unrestrained diameter. After sufficient pressure has been released, the pressure relief spring 44 tries to move the poppet 41 and valve guide 42 back to the closed position illustrated in FIG. 1. However, the seal 41a preferably prevents this movement by engaging the coupling interface end 11b of the coupling member 11 adjacent the cylindrical seating surface 36. This prevents the seal 41a from re-entering the cylindrical seating surface 36 after the poppet 41 and seal 41a have moved to their vent position illustrated in FIG. 2. The protruding poppet 41 and seal 41a provide a visual indicator that an over pressure condition has occurred and that the coupling member 11 and its associated fluid component should not be used.

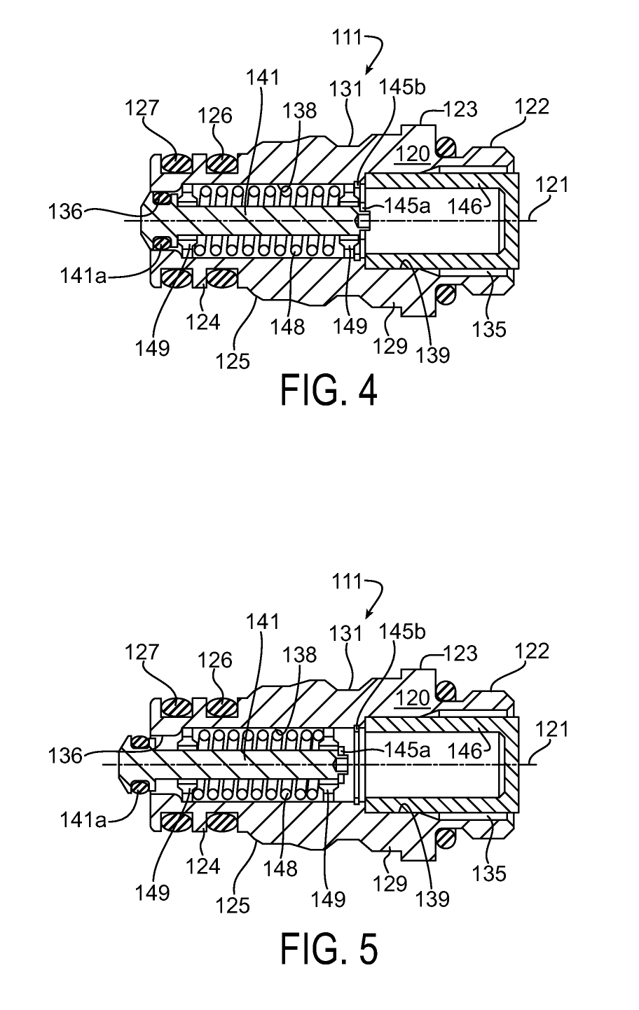

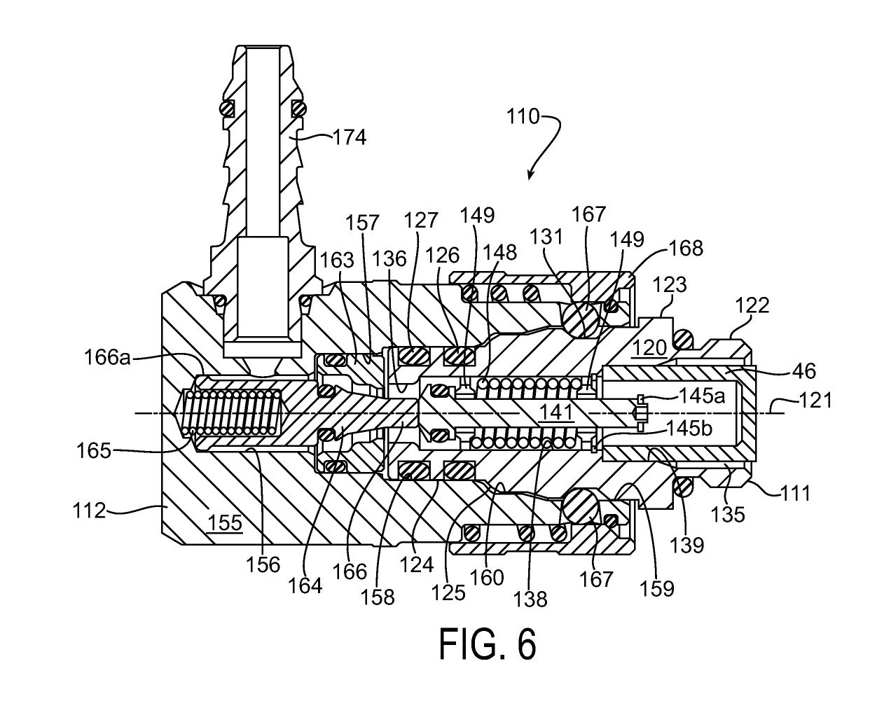

Referring now to FIGS. 4-6, a second embodiment of a coupling member 112 according to certain principles of this invention is illustrated. The reference numbers used in FIGS. 1-3 and described above are applied to structurally or functionally similar components in FIGS. 4-6, but with a “1” prefix added. In the embodiment illustrated in FIGS. 4-6, the valve spring 43 and pressure relief spring 44 and spring retainer 42 of FIGS. 1-3 are replaced with a dual function single valve and pressure relief spring 148 and two identical spring retainers 149. The spring retainers 149 are each slidably arranged in the bore 138, and the spring 148 biases the poppet 141 and seal 141a to the closed position illustrated in FIG. 4 when the coupling member 112 is disconnected from the coupling member 111. When the coupling members 111 and 112 are connected, the poppet 141 and seal 141a are moved to their fully opened positions illustrated in FIG. 6. An over pressure condition as described above will move the poppet 141 and seal 141a against the bias of the dual function spring 148 to the pressure relief position illustrated in FIG. 5. After a pressure relief or vent occurrence, the seal 141a will prevent the poppet 141 and seal 141a from returning to their closed positions.

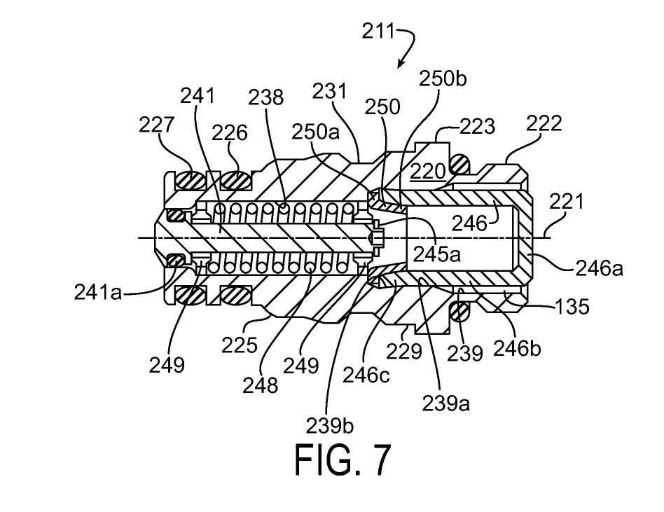

Referring now to FIG. 7, a third embodiment of a coupling member 212 according to certain principles of this invention is illustrated. The reference numbers used in FIGS. 4-6 and described above are applied to structurally or functionally similar components in FIG. 7, but with the “1” prefix in FIGS. 4-6 replaced with a “2” prefix in FIG. 7. As shown in FIG. 7, the bore portion 239 in which retainer or filter 246 is received includes a generally cylindrical portion 239a that extends longitudinally inwardly from a lateral end face of housing 220. The cylindrical portion 239a terminates at a generally cone shaped portion 239b, and the cone shaped portion 239b terminates at the step that joins larger diameter bore portion 239 with bore portion 238. A generally cone shaped rigid metal flare member 250 is disposed in the cone shaped bore portion 239b. The flare member 250 includes a stop portion 250a that is adjacent the intersection of the bores 239 and 238, and a cone shaped flare portion 250b that extends generally coextensively with the cone shaped bore portion 239b. The cup shaped filter 246 includes a generally flat disk shaped closed end portion 246a and a generally cylindrical body portion 246b. During assembly of the filter 246 into the coupling member 211, the free end of the body portion 246b is pushed to the left into the bore portion 239a until it reaches the bore portion 239b and engages the flare portion 250b. Additional assembly force is then applied to the disk shaped closed end portion 246a of the filter 246, to further displace the filter 246 to the left and cause the flare portion 250b of the flare member 250 to expand the free end of the filter portion 246b with an interference fit into the space defined between the flare portion 250b and the conical bore portion 239b. The free end of the filter 246 is in this manner is flared outwardly to form a radially outwardly larger diameter flared filter portion 246c that engages the flared bore portion 239b. The radially outwardly flared filter portion 246c retains the filter 246 in the bore 239, and retains the valve poppet 241 and spring 248 and valve guide 249 in place. The stop portion 250a of the flare member 250 replaces the retaining ring 45b, 145b used in the first and second embodiments, respectively.

Presently preferred embodiments of the invention are shown in the drawings and described in detail above. The invention is not, however, limited to these specific embodiments. Various changes and modifications can be made to this invention without departing from its teachings, and the scope of this invention is defined by the claims set out below. Also, while the terms first and second, one and another, left and right are used to more clearly describe the structure and operation of the preferred embodiments, these terms are used for purposes of clarity and may be interchanged as appropriate. Also, the terms open or opened and close or closed may include partially or fully opened or closed, according to the context. Further, separate components illustrated in the drawings may be combined into a single component, and single components may be provided as multiple parts.

1. A fluid coupling member comprising a housing, a bore in the housing having a longitudinal axis, a poppet slidably disposed in the bore, a valve seating surface in the bore between ends of the housing, a spring assembly biasing the poppet toward a closed position engaging the valve seating surface to fully close fluid communication between the ends, the poppet being movable in one longitudinal direction toward one of the ends against the bias of the spring assembly to open fluid communication between the ends, and the poppet being movable in another longitudinal direction opposite the one direction against the bias of the spring assembly to open fluid communication between the ends.

2. A fluid coupling member as set forth in claim 1, wherein one of the ends is a fluid coupling member interface end and the other of the ends is a fluid component attachment end.

3. A fluid coupling member as set forth in claim 2, wherein the poppet is movable toward the fluid component attachment end when the coupling member is connected to another coupling member.

4. A fluid coupling member as set forth in claim 3, wherein the poppet is movable away from the fluid component attachment end when the coupling member is disconnected from another coupling member.

5. A fluid coupling member as set forth in claim 2, wherein the spring assembly includes a valve spring biasing the poppet toward the fluid coupling interface end when the coupling member is connected to another coupling member, and a pressure relief spring biasing the poppet toward the fluid component attachment end when the coupling member is disconnected from another coupling member.

6. A fluid coupling member as set forth in claim 5, wherein the spring assembly includes a valve guide, the valve guide is longitudinally slidable relative to the housing bore and relative to the poppet, the valve spring acts between the poppet and the valve guide, and the pressure relief spring acts between the housing and the valve guide.

7. A fluid coupling member as set forth in claim 2, wherein the spring assembly includes no more than one spring, the one spring biases the poppet toward its closed position when the poppet is moved in the direction away from the fluid component attachment end, and the one spring biases the poppet toward its closed position when the poppet is moved in the other direction toward the fluid component attachment end of the housing.

8. A fluid coupling as set forth in claim 7, wherein the spring assembly includes two valve guides, each of the valve guides is slidable relative to the housing and relative to the poppet, and the one spring acts between the two valve guides.

9. A fluid coupling as set forth in claim 1, wherein the seating surface is a generally cylindrical surface, the poppet includes an elastomeric seal, the seal has a resiliently deformed diameter engaging the generally cylindrical seating surface when the poppet is in the closed position, and the elastomeric seal has a free diameter substantially greater than its resiliently deformed diameter when the poppet is in the open position in the direction away from the fluid component attachment end, and the portion of the seal intermediate its resiliently deformed diameter and its free diameter engages a portion of the interface end of the housing to retain the poppet in the open position against the bias of the spring assembly after the poppet is moved from its closed position to its open position toward the interface end.

10. A fluid coupling member as set forth in claim 2, wherein the bore includes a retainer receiving portion near the fluid component attachment end of the bore, the retainer receiving portion of the bore includes a generally cylindrical nominal diameter portion and a larger diameter portion intermediate the nominal diameter portion and the seating surface, a retainer is disposed in the retainer receiving portion of the bore, the retainer has a nominal diameter portion disposed in the nominal diameter retainer receiving portion of the bore, and the retainer has a larger diameter portion disposed in the larger diameter retainer receiving portion of the bore.

11. A fluid coupling member as set forth in claim 10, wherein the larger diameter retainer receiving portion of the bore is generally conical.

12. A fluid coupling member as set forth in claim 11, including a flaring member disposed in the larger diameter retainer receiving portion of the bore, the flaring member and the larger diameter retainer receiving portion of the bore define a generally conical space, and the larger diameter portion of the retainer is received in the generally conical space.

13. A fluid coupling as set forth in claim 12, wherein the retainer secures the spring assembly in the bore.

14. A fluid coupling as set forth in claim 10, wherein the retainer is a porous metal filter.

15. A fluid coupling member comprising a housing, a bore in the housing having a longitudinal axis, the bore including a retainer receiving portion near one end of the bore, the retainer receiving portion of the bore includes a generally cylindrical nominal diameter portion and a larger diameter portion intermediate the nominal diameter portion and other end of the bore, a retainer disposed in the retainer receiving portion of the bore, the retainer having a nominal diameter portion disposed in the nominal diameter retainer receiving portion of the bore, and the retainer having a larger diameter portion disposed in the larger diameter retainer receiving portion of the bore.

16. A fluid coupling member as set forth in claim 15, wherein the larger diameter retainer receiving portion of the bore is generally conical.

17. A fluid coupling member as set forth in claim 16, including a flaring member disposed in the larger diameter retainer receiving portion of the bore, the flaring member and the larger diameter retainer receiving portion of the bore define a generally conical space, and the larger diameter portion of the retainer is received in the generally conical space.

18. A fluid coupling member as set forth in claim 17, including a valve assembly having a poppet and a spring assembly disposed in the bore near the one end of the bore, and the retainer secures the valve assembly in the bore.

19. A fluid coupling as set forth in claim 15, wherein the retainer is a porous metal filter.
